(19) United States
(12) Patent Application Publication
(10) Pub. No.: US 2014/0236778 A1
(43) Pub. Date: Aug. 21, 2014

(54) TRUCK INVENTORY LOCATOR

(71) Applicant: Anthony Villardito, Brookfield, IL (US)

(72) Inventor: Anthony Villardito, Brookfield, IL (US)

(21) Appl. No.: 13/770,142

(22) Filed: Feb. 19, 2013

(51) Int. Cl. G06Q 10/08

(52) U.S. Cl. CPC G06Q 10/087
USPC 705/28

(57) ABSTRACT

Various embodiments for managing inventory are disclosed. Some embodiments include receiving a request for an item at a particular location, and coordinating a transfer of the requested item to the particular location in response to determining that a vehicle has the requested item and is within a vicinity of the particular location.

### FIELD OF THE INVENTION

Various embodiments relate to inventory management systems, and more, particularly to managing inventory distributed across multiple locations.

### BACKGROUND OF THE INVENTION

Technicians may travel to a customer's residence or place of business in order to service or repair an item. Such servicing and/or repairing may require replacement parts and/or specialized tools. Parts and/or tools for a service call may be anticipated based on information received prior to dispatching a technician to the customer's location. However, sometimes the parts and/or tools desired for a service call may not be determined until the technician arrives at the location and has a chance to inspect the item first hand. As a result, the technician in some circumstances may not have the parts and/or tools desired for the job.

For example, an inventory of parts, products, and/or tools may be maintained in a service vehicle used to transport the technician to the customer's location. While the service vehicle may maintain an inventory of parts, products, and/or tools for common services, the service vehicle may lack parts and/or tools for less common services. When a service vehicle does not have the desired part, product, and/or tool in its inventory, the service call is less profitable because a second attempt to the customer's location is required. Furthermore, completing a service call in a single visit improves customer satisfaction since follow-up visits are commonly inconvenient to the customer.

Limitations and disadvantages of conventional and traditional approaches should become apparent to one of skill in the art, through comparison of such systems with aspects of the present invention as set forth in the remainder of the present application.

### BRIEF SUMMARY OF THE INVENTION

Apparatus, systems, and methods of managing inventory, and more, particularly apparatus, systems, and methods of managing inventory distributed across multiple locations are substantially shown in and/or described in connection with at least one of the figures, and are set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 shows an inventory management system in accordance with an embodiment of the present invention.

FIG. 2 shows a block diagram for an embodiment of a computing device that may be used to implement various aspects of the inventory management system in FIG. 1.

FIG. 3 shows a flowchart of a technician management process implemented by an embodiment of the inventory management system in FIG. 1.

FIG. 4 shows a flowchart of a vehicle location tracking process implemented by an embodiment of the inventory management system in FIG. 1.

FIG. 5 shows a flowchart of an inventory process implemented by an embodiment of the inventory management system in FIG. 1.

FIG. 6 shows a flowchart of a process implemented by an embodiment of the inventory management system in FIG. 1.

### DETAILED DESCRIPTION OF THE INVENTION

Aspects of the present invention are related to inventory management systems. More specifically, certain embodiments of the present invention relate to managing inventory distributed across multiple locations wherein at least some of the multiple locations are mobile.

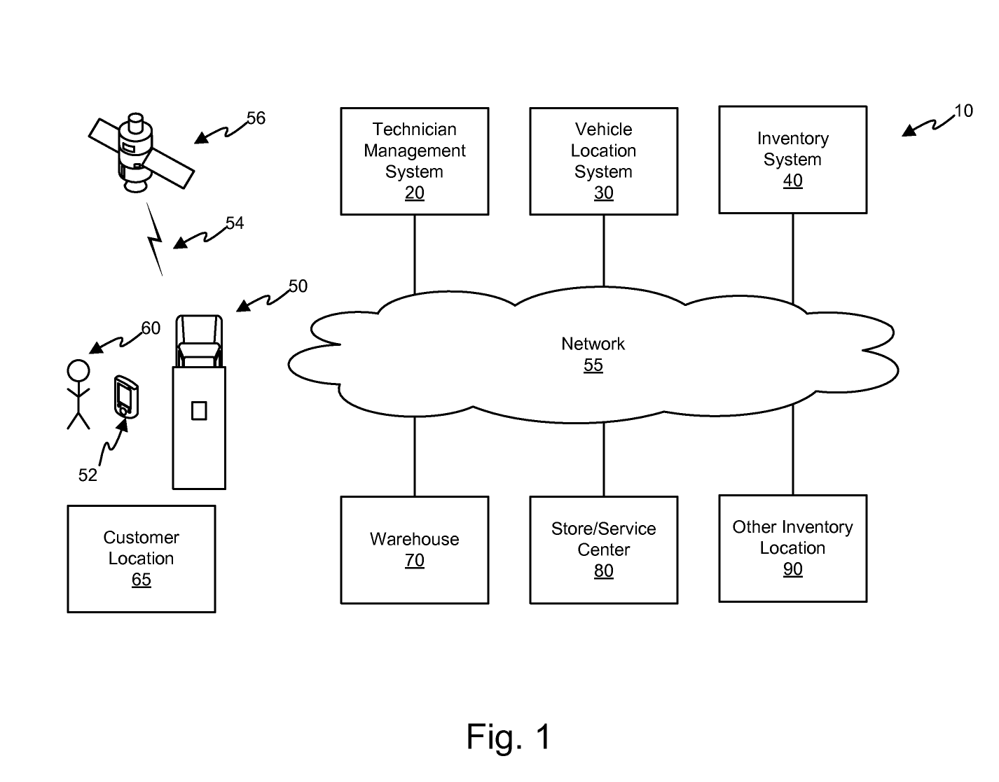

Referring now to FIG. 1, a block diagram of an inventory management system 10 is provided in the context of technicians providing repair and/or other services at various customer locations. However, the inventory management system 10 may also be suitable for other contexts such as, for example, providing same day or next day delivery for an e-commerce vendor.

As shown, the inventory management system 10 may include a technician management system 20, a vehicle location system 30, an inventory system 40, a fleet of trucks and/or other service vehicles 50, and a network 55 which cooperate to support one or more technicians 60 and their handling of service calls. In some embodiments, the technician management system 20, the vehicle location system 30, and the inventory system 40 may each be separately implemented using one or more computing devices that are programmed to provide the functionality described herein. Moreover, the service vehicles 50 and/or technicians 60 may have associated computing devices which permit the service vehicles 50 and/or technicians 60 to communicate and interact with the technician management system 20, the vehicle location system 30, and/or the inventory system 40. In some embodiments, a single computing device may implement one or more aspects of systems 20, 30, and 40. For example, each of the system 20, 30, and 40 may share one or more database servers that store relevant information (e.g., customer data, inventory data, vehicle location data, etc.) for such systems.

The technician management system 20 may manage the handling of service calls received from customers. In particular, the technician management system 20 may receive customer requests for service calls at customer specified locations. The technician management system 20, based on such customer requests, may schedule dates and times for such service calls as well as allocate resources to ensure appropriate technician(s), vehicle(s), part(s), tool(s), etc. are assigned to handle the requests in a timely manner. As explained in more detail below, the technician management system 20 may utilize vehicle location information of the vehicle location system 30, and inventory information of the inventory system 40 in order to select technicians, service vehicles, products, part, tools, etc. for handling the customer requests.

The vehicle location system 30 may track the current geographic location of service vehicles 50. During use of the inventory management system 10, technicians 60 may use service vehicles 50 to travel to customer specified locations 65 in order to provide on-site service. As a result, service vehicles 50 do not remain at fixed geographic locations but instead move from one geographic location to another as a result of processing service calls. The vehicle location system 30, therefore, may track movement of the service vehicles 50 to maintain a current geographic location of the service vehicles 50.

To this end, each service vehicles 50, in one embodiment, includes an associated geographic positioning system (GPS) receiver. The GPS receiver is configured to receive signals 54 from GPS satellites 56 and ascertain the geographic position of the GPS receiver based on such received GPS satellite signals 54. The service vehicle 50 may further include an associated communications interface (e.g., cellular transceiver, a WiMAX transceiver, a satellite transceiver, etc.) that is configured to communicate with vehicle location system 30 via network 55 in order to provide the vehicle location system 30 with updates regarding the current position of the service vehicle associated with the GPS receiver. In such a manner, the vehicle location system 30 may maintain a real-time and/or near real-time location of each service vehicle 50 while the vehicle 50 is at a customer's location as well as while the vehicle 50 is in transit to and/or from customer locations.

In some embodiments, the GPS receiver and communications interface may be provided by a single computing device 52 mounted to the service vehicle 50 and/or carried by a technician 60 riding in the service vehicle 50. For example, tablet computing devices and smart phone devices commonly include GPS capabilities as well as wireless Internet capabilities. Such computing devices 52 may be used to directly track the service vehicle 50 in which the device is mounted and/or indirectly track the service vehicle 50 via a technician 60 who is associated with the service vehicle 50 and who is carrying such a computing device 52.

In other embodiments, the vehicle tracking system 30 may track the vehicles 50 in a coarser manner than the real-time or near real-time manner supported by GPS systems. For example, a technician 60 may provide periodic position updates using a cellular phone, a smart phone, a laptop, an in-dash computing device, and/or some other computing device associated with the technician 60 and/or vehicle 50. In particular, the technician 60 may provide vehicle tracking system 30 with notifications upon arriving at a customer location 65, returning to a service center 80, and/or at other times. Based upon such notifications and information of the technician management system 20, the vehicle location system 30 may ascertain the current location of the vehicle 50 (e.g., at the address for customer A) and/or estimate the current location of the vehicle 50. For example, if the technician 60 provides an notification upon completing a job at customer A, the vehicle location system 30 may ascertain the address of customer A and the address of the next customer B based on information from the technician management system 30 and estimate that the vehicle 50 is likely between the two obtained addresses. The vehicle location system 30 may even further refine such estimate based upon average rates of travel and the time notifications are received.

The inventory system 40 may track inventory such as parts, tools, products, and/or other items distributed across various inventory locations. In particular, inventory system 40 may track inventory found on-board vehicles 50, in warehouses 70, in stores and/or service centers 80, and/or at other inventory locations 90. To this end, the inventory system 40 may receive inventory updates in order to maintain an accurate view of inventory available from each of the inventory sources 50, 70, 80, and 90. In particular, the inventory system 40 may receive real-time notifications in response to an item being added to the inventory of one of the inventory sources 50, 70, 80, and 90 and update the inventory counts for the inventory source 50, 70, 80, and 90 accordingly. Similarly, the inventory system 40 may receive real-time notifications in response to an item being removed from the inventory of one of the inventory sources 50, 70, 80, and 90 and update the inventory counts for the inventory source 50, 70, 80, and 90 accordingly.

In some embodiments, the inventory system 40 may not locally track each of the inventory sources 50, 70, 80, and 90. In such embodiments, the inventory system 40 may also query computing devices associated with inventory sources 50, 70, 80, and 90 to determine whether such sources 50, 70, 80, and 90 have an item of interest and/or to determine the quantity of an item in the inventory of a particular source 50, 70, 80, and 90.

The network 55 may include a number of private and/or public networks such as, for example, wireless and/or wired LAN networks, cellular networks, satellite networks, and the Internet that collectively provide a communication path and/or paths between systems 20, 30, and 40 as well as computing device associated with the inventory sources 70, 80, 90, service vehicles 50, and/or technicians 60.

As noted above, the service vehicles 50 and/or technicians 60 may use computing devices to communicate and/or otherwise interact with systems 20, 30, and 40 via network 55. Such computing devices may include laptops, tablets, a smart phones, cellular phones, and/or some other type of computing device which enables communication with the inventory management system 10 via the network 55. Also as noted above, the systems 20, 30, and 40 may include one or more computing devices. Such computing devices may include web servers, database servers, routers, load balancers, and/or other computing and/or networking devices that operate to manage inventory distributed among service vehicles 50 and other inventory locations 70, 80, and 90.

It should be appreciated that FIG. 1 depicts the inventory management system 10 at a high level. The inventory management system 10 may be implemented in numerous different manners using a wide range of different computing devices, platforms, networks, etc. Moreover, those skilled in the art readily appreciate that aspects of the inventory management system 10 may be implemented using a client/server architecture, a peer-to-peer architecture, and/or another networking architecture.

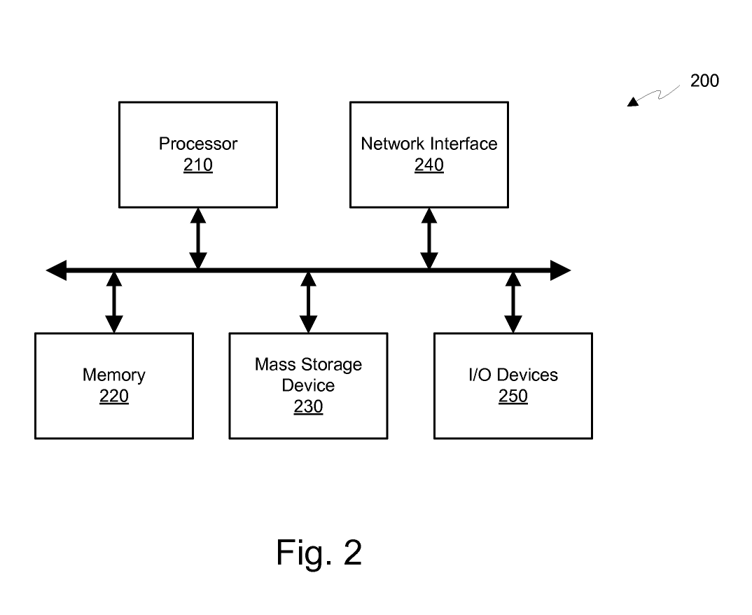

As noted above, the systems 20, 30, and 40 may include a computing devices. Moreover, inventory sources 50, 70, 80, 90 and technicians 60 may have associated computing devices. FIG. 2 provides a block diagram of a computing device 200 suitable for implementing a computing device of the inventory management system 10. As shown, the computing device 200 may include a processor 210, a memory 220, a mass storage device 230, a network interface 240, and various input/output (I/O) devices 250. The processor 210 may be configured to execute instructions, manipulate data and generally control operation of other components of the computing device 200 as a result of its execution. To this end, the processor 210 may include a general purpose processor such as an x86 processor or an ARM processor which are available from various vendors. However, the processor 210 may also be implemented using an application specific processor and/or other logic circuitry.

The memory 220 may store instructions and/or data to be executed and/or otherwise accessed by the processor 210. In some embodiments, the memory 220 may be completely and/or partially integrated with the processor 210.

In general, the mass storage device 230 may store software and/or firmware instructions which may be loaded in memory 220 and executed by processor 210. The mass storage device 230 may further store various types of data which the processor 210 may access, modify, and/otherwise manipulate in response to executing instructions from memory 220. To this end, the mass storage device 230 may comprise one or more redundant array of independent disks (RAID) devices, traditional hard disk drives (HDD), sold-state device (SSD) drives, flash memory devices, read only memory (ROM) devices, etc.

The network interface 240 may enable the computing device 200 to communicate with other computing devices via network 55. To this end, the networking interface 240 may include a wired networking interface such as an Ethernet (IEEE 802.3) interface, a wireless networking interface such as a WiFi (IEEE 802.11) interface, a radio or mobile interface such as a cellular interface (GSM, CDMA, LTE, etc), and/or some other type of networking interface capable of providing a communications link between the computing device 200 and network 55 and/or another computing device.

Finally, the I/O devices 250 may generally provide devices which enable a user to interact with the computing device 200 by either receiving information from the computing device 200 and/or providing information to the computing device 200. For example, the I/O devices 250 may include display screens, keyboards, mice, touch screens, microphones, audio speakers, GPS receivers, etc.

While the above provides some general aspects of a computing device 200, those skilled in the art readily appreciate that there may be significant variation in actual implementations of a computing device. For example, a smart phone implementation of a computing device generally uses vastly different components and may have a vastly different architecture than a database server implementation of a computing device. However, despite such differences, computing devices still generally include processors that execute software and/or firmware instructions in order to implement various functionality. As such, the above described aspects of the computing device 200 are not presented from a limiting standpoint but from a generally illustrative standpoint. The present application envisions that aspects of the present application will find utility across a vast array of different computing devices and the intention is not to limit the scope of the present application to a specific computing device and/or computing platform beyond any such limits that may be found in the appended claims.

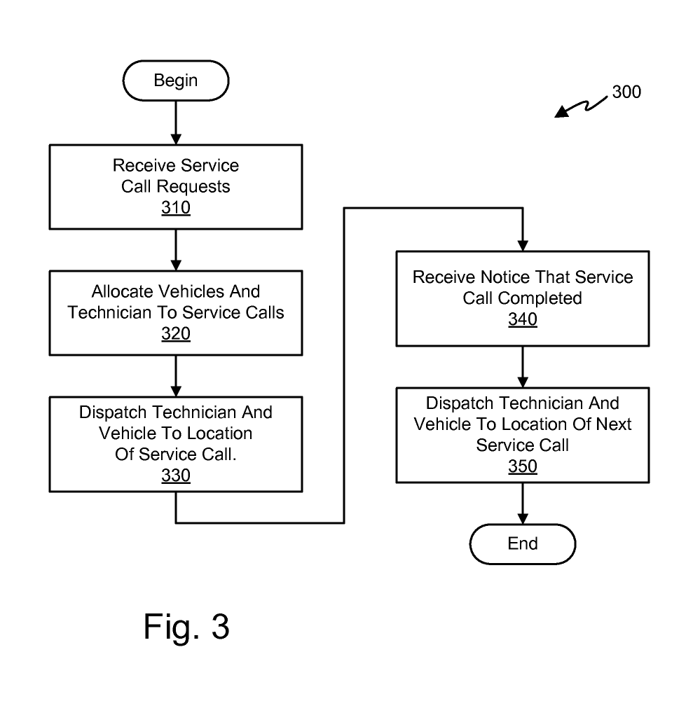

Referring now to FIGS. 3-6, operation of the technician system 20, location system 30, inventory system 40, and inventory management system as a whole are respectively addressed in further detail. In particular, FIG. 3 shows a flowchart of technician management process 300 implemented by one embodiment of technician management system 20. As shown, the technician management system 20 at 310 may receive a request for a service call at a custom specified location 65. The technician management system 20 may support various different manners for the generation and receipt of service call requests. For example, the technician management system 20 may receive requests as a result of a customer calling into a call center (not shown) and providing details of the request to a service center employee who enters such information into the technician management system 20 via a computing device of the service center. In other embodiments, the technician management system 20 may permit customers to enter service call requests via a website that presents forms for completion by the customer. Other forms of receiving a service call request from a customer are contemplated.

At block 320, the technician management system 20 may allocate resources to the service calls received. In particular, the technician management system 20 may determine, based upon the information received for the service calls, the technician skills required to perform the requested service and the tools, parts, and/or products likely required to perform the service. The technician management system 20 may then select a technician 60 with the appropriate skill set for a particular service request or a set of service requests and assign, to the selected technician 60, a service vehicle 50 that already has on-board the tools, parts, and/or products likely to perform the requested services. In some embodiments, instead of assigning a service vehicle 50 with the appropriate tools, parts, and/or products, the technician management system 20 may request that appropriate tools, parts, and/or products be loaded upon the assigned service vehicle 50 prior to dispatching the technician 60 to the customer location 65.

The technician management system 20 at 330 may then dispatch the selected technician 60 to the customer location 65. The technician management system 20 may support various ways of effecting such dispatch. For example, the technician management system 20 may generate a work order report which is printed and physically delivered to the selected technician 60. The technician management system 20 may also support electronic deliver of such a work order report via a computing device 52 associated with the technician. Other ways of providing the technician 60 with details regarding the service call and thus dispatching the technician 60 to the customer location 65 in order to handle the service call are contemplated.

After dispatching the technician 60, the technician management system 20 at 340 may receive a notice that the technician 60 has completed the service call. For example, the technician 60 may provide such a notice to the technician management system 20 via a computing device 52 associated with the technician 60. In response to such notice, the technician management system 20 may dispatch the technician 60 to another location 65 in order to handle another service call. In some embodiments, the technician management system 20 may generate a complete schedule for the technician 60 prior to dispatching the technician 60 to the first customer location 65 of the day. The technician management system 20 may alter or revise this schedule in response to receiving the notice at 340 based on current inventory of the service vehicle 50, newly received service calls, and/or unexpected delays (e.g., service call took longer than anticipated) or cancelations (e.g., customer called and canceled appointment).

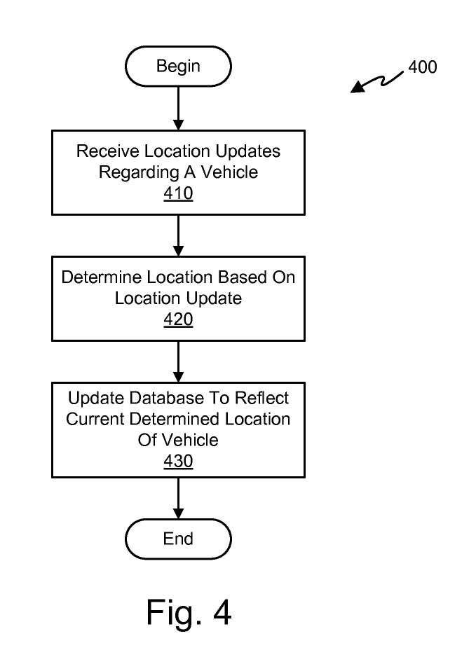

Referring now to FIG. 4, a flowchart is shown which depicts a vehicle location tracking process 400 implemented by one embodiment of the vehicle location system 30. At block 410, the vehicle location system 30 may receive location updates for one or more vehicles 50. As noted above, the vehicles 50 may have associated computing devices with GPS capabilities. As such, the vehicle location system 30 may receive periodic updates from such computing devices which provide a current GPS location of the computing device and associated vehicle 50. Accordingly, the vehicle location system 30 at block 420 may determine the location of a vehicle 50 based upon the received GPS location information and at block 430 update a database to reflect the currently determined location of the vehicle.

However, as explained above, the vehicles 50 in some embodiments may not have associated GPS receivers. In such situations, the truck location system 30 may still track in a more coarse manner the location of the vehicles 50. For example, the vehicle location system 30 at 410 may receive a notifications from the technician 60 via an associated computing device upon arriving at a customer location 65, upon returning to a service center 80, upon completing a service call, and/or at other times. Based upon such notifications, the vehicle location system 30 at 420 may determine the current location of the vehicle 50 (e.g., at the address for customer A) and/or estimate the current location of the vehicle 50. For example, if the technician 60 provides an notification upon completing a job at customer A, the vehicle location system 30 may ascertain the address of customer A and the address of the next customer B based on information from the technician management system 30 and estimate that the vehicle 50 is likely between the two obtained addresses. The vehicle location system 30 may even further refine such estimate based upon average rates of travel and the time notifications are received.

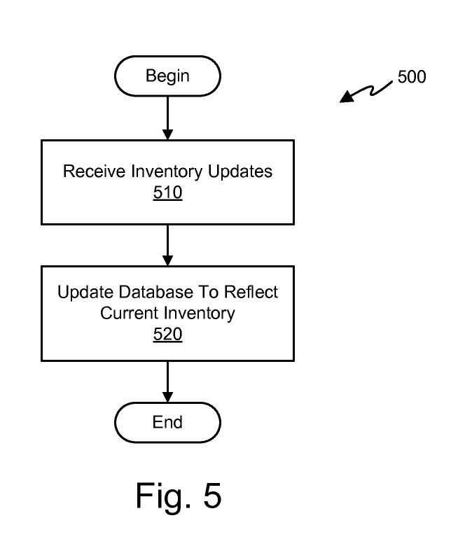

Referring now to FIG. 5, a flowchart is shown which depicts an inventory update process 500 implemented by one embodiment of the inventory system 40. At block 510, the inventory system 40 may receive an inventory update for one or more of the inventory sources 50, 70, 80, and 90. The inventory system 40 at block 520 may update a database to reflect changes in the inventory of such sources 50, 70, 80, and 90.

In some embodiments, computing devices associated with the inventory sources 50, 70, 80, and 90 may send periodic updates to reflect changes in inventory since the last periodic update. Computing devices associated with the inventory sources 50, 70, 80, 90 may also send updates in response to requests received from the inventory system 40. Computing devices associated with the inventory sources 50, 70, 80, and 90 may also send updates in response to detected changes to inventory. For example, a technician 60, in the process of handling a service call, may use and/or consume parts, products, and/or tools from the on-board inventory of a vehicle 50. The technician 60 via a computing device associated with the vehicle 60 may provide information that indicates the remove of such items from the on-board inventory. The computing device in turn may provide the inventory system 40 with updates to reflect such change.

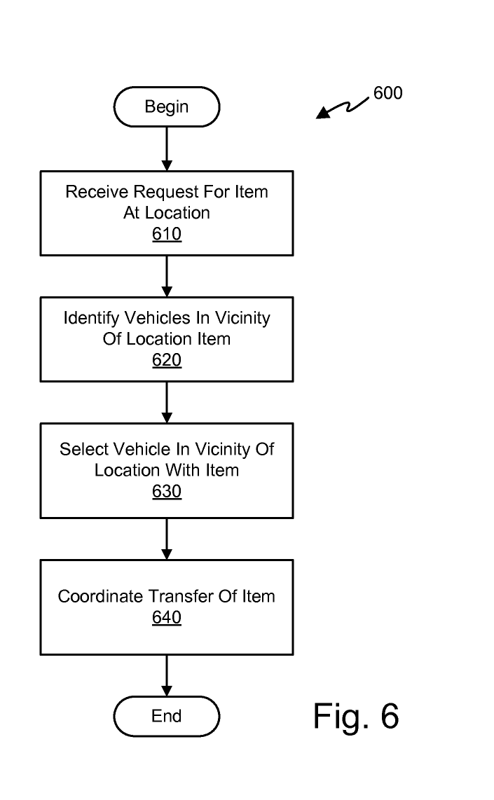

Now referring now to FIG. 6, a flowchart is shown which depicts an inventory management process 600 implemented by one embodiment of the inventory management system 10. At block 610, the inventory management system 10 may receive a request for an item at a location such as a customer location 65. As noted above, a technician 60 may be dispatched to a customer location 65 in order to provide on-site services. In the course of providing such services, the technician 60 may determine that a part, product, tool, and/or some other item is desired in order to complete the on-site services. Moreover, the technician 60 may determine that the item is not present in the on-board inventory of his service vehicle 50. Accordingly, the technician 60 via an associated computing device may send a request to the inventory management system 10 for the desired item.

In response to such request, the inventory management system 10 at 620 may identify vehicles in the vicinity of the customers location that have the requested item in their on-board inventory. To this end, the technician management system 20 may obtain vehicle location information from the vehicle location system 30 and inventory information from the inventory system 40. Based on such inventory information, the technician management system 20 may locate vehicles 50 and/or other inventory sources 70, 80, 90 that have the requested item. The technician management system 20 may further determine which of such vehicles 50 and/or other inventory sources 70, 80, 90 are in a particular vicinity (e.g., 5 mile, 10 mile, etc. radius) or will be in the particular vicinity within a specified time period (e.g., 10 minutes, 20 minutes, 30 minutes, etc.). At 630, the inventory management system 10 may select a vehicle 50 from among the vehicles 50 identified as having the item and being within the vicinity of the customer location 65. The inventory management system 10 in selecting such a vehicle 50 may take into account various other factors in an attempt to increase profitability of ongoing service calls and timeliness of completing such calls. For example, the inventory management system 10 may take into account (i) whether a particular vehicle 50 is associated with a currently ongoing service call, (ii) whether a particular vehicle 50 is in transit to another customer location, (iii) an anticipated time of completion of a service call associated with the vehicle, etc.

After selecting a vehicle 50, the inventory management system 10 may coordinate a deliver of the requested item to the technician 60. For example, the inventory management system 10 may send a message that requests the selected vehicle 50 to deliver the item to technician 60 at the customer location 65. In some embodiments, the inventory management system 10 may send messages to the requesting technician 60 as well as the technician 60 associated with the selected vehicle 50 that identify a location and time for the two technicians 60 to meet and transfer the requested item. Other ways of effectuating the transfer of the item from the selected vehicle 60 to the requesting technician 50 are contemplated.

Various embodiments of the invention have been described herein by way of example and not by way of limitation in the accompanying figures. For clarity of illustration, exemplary elements illustrated in the figures may not necessarily be drawn to scale. In this regard, for example, the dimensions of some of the elements may be exaggerated relative to other elements to provide clarity. Furthermore, where considered appropriate, reference labels have been repeated among the figures to indicate corresponding or analogous elements.

Moreover, certain embodiments may be implemented as a plurality of instructions on a tangible, computer readable storage medium such as, for example, flash memory devices, hard disk devices, compact disc media, DVD media, EEPROMs, etc. Such instructions, when executed by one or more computing devices, may enable result in the one or more computing devices promoting the sale of products and/or one or more of the other aspects of the e-commerce environment 10 described above.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment or embodiments disclosed, but that the present invention encompasses all embodiments falling within the scope of the appended claims.

What is claimed is:

1. A method, comprising:
receiving a request for an item at a particular location; and
coordinating a transfer of the requested item to the particular location in response to determining that a vehicle has the requested item and is within a vicinity of the particular location.

2. The method of claim 1, further comprising:
tracking locations for a plurality of vehicles; and
identifying vehicles in the vicinity of the particular location based on the tracked locations for the plurality of vehicles.

3. The method of claim 1, further comprising:
requesting each vehicle of a plurality of vehicles to indicate whether the vehicle has the requested item; and
selecting the vehicle with which to coordinate the transfer based on indications received from the plurality of vehicles.

4. The method of claim 1, further comprising:
receiving inventory updates from a plurality of vehicles;
maintaining an inventory for each vehicle of the plurality of vehicles based on the received inventory updates; and
selecting the vehicle with which to coordinate the transfer based on inventory maintained for each vehicle of the plurality of vehicles.

5. The method of claim 1, wherein said coordinating comprises requesting the vehicle to deliver the requested item to the particular location.

6. The method of claim 1, wherein said coordinating comprises:
requesting the vehicle to deliver the requested item to the another location within a second vicinity of the particular location; and
requesting a user at the particular location to pick-up the requested item from the vehicle at the another location.

7. The method of claim 1, wherein the requested item is a tool required a service to be performed at the particular location.

8. The method of claim 1, wherein the requested item is a part required for a service to be performed at the particular location.

9. The method of claim 1, wherein the requested item is a product to be delivered to the particular location.

10. A computing system for managing inventory, comprising:
one or more processors; and
one or more storage devices comprising a plurality of instructions, wherein the plurality of instructions, in response to being executed by the one or more processors, configure the computing system to process a request for an item at a service location, track inventory for each vehicle from a plurality of vehicles, select a vehicle from the plurality of vehicles based on inventory and location of the vehicle, and request a transfer of the item from the selected vehicle to the service location.

11. The computing system of claim 10, wherein the one or more processors and the one or more storage devices define:
a tracking system configured to track a location for each vehicle from the plurality of vehicles;
a inventory system configured to track inventory for each vehicle from the plurality of vehicles; and
a management system configured to select the vehicle based on inventory information received from the inventory system and location information received from the tracking system.

12. The computing system of claim 10, wherein the plurality of instructions further configure the computing system to request each vehicle of a plurality of vehicles to indicate whether the vehicle has the requested item, and select the vehicle with which to coordinate the transfer based on indications received from the plurality of vehicles.

13. The computing system of claim 10, wherein the plurality of instructions further configure the computing system to process inventory updates received from the plurality of vehicles, update an inventory for each vehicle of the plurality of vehicles based on the received inventory updates, and select the vehicle with which to coordinate the transfer based on inventory for each vehicle of the plurality of vehicles.

14. The computing system of claim 10, wherein the plurality of instructions further configure the computing system to send a request the vehicle for delivery of the requested item to the particular location.

15. The computing system of claim 10, wherein the plurality of instructions further configure the computing system to send a request to the vehicle for delivery of the requested item to the another location within a second vicinity of the service location, and send a notification the service location that indicates availability of the requested item at the another location.

16. A system for managing inventory, comprising:
a plurality of vehicles comprising an inventory of on-board items;
a tracking system configured to track a location for each vehicle from the plurality of vehicles;
a inventory system configured to track on-board inventory for each vehicle from the plurality of vehicles; and
a management system configured to process a request for an item at a customer's location, select a vehicle from the plurality of vehicles based on inventory and location of the vehicle received from the location system and inventory system, and request a transfer of the item from the selected vehicle to a customer's location.

17. The system of claim 16, wherein each vehicle comprises:
a global position system receiver configured to track a location of the vehicle based on signals received from global positioning satellites; and
a transmitter configured to provide the location of the vehicle to the tracking system.

18. The system of claim 16, further comprising a computing device associated with each vehicle, wherein the computing device is configured to transmit the request for the item to the management system.

19. The system of claim 16, further comprising a computing device on-board each vehicle, wherein the computing device is configured to transmit the request for the item to the management system.

20. The system of claim 18, further comprising a mobile computing device to be carried by a person associated with each vehicle, wherein the computing device is configured to transmit the request for the item to the management system.
